(19) United States
(12) Patent Application Publication
(10) Pub. No.: US 2003/0189405 A1
(43) Pub. Date: Oct. 9, 2003

(54) Method for forming barrier ribs for use in a plasma display panel

(75) Inventors: Yoshimi Shirakawa, Kawasaki (JP); Akihiro Fujinaga, Kawasaki (JP); Kazunori Ishizuka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Kawasaki (JP)

(21) Appl. No.: 10/401,781

(22) Filed: Mar. 31, 2003

(30) Foreign Application Priority Data
Apr. 8, 2002 (JP) JP 2002-105680

(51) Int. Cl. H01J 9/24; H01J 17/49

(52) U.S. Cl. 313/582; 445/24

(57) ABSTRACT

The present invention is a method for forming ribs for a plasma display panel. The method includes: forming a rib material layer having a predetermined thickness; forming band-shaped barrier rib masks on the rib material layer, each of the barrier rib masks having a pattern corresponding to a barrier rib; forming at least one dummy rib mask for forming at least one dummy rib for each barrier rib, the dummy rib mask being spaced apart from an end of each barrier rib mask in a longitudinal direction of the barrier rib mask; and performing sandblast by blowing abrasive onto the rib material layer and the barrier rib and dummy rib masks, thereby forming the barrier ribs.

### CROSS-REFERENCE TO RELATED APPLICATION

This application is related to Japanese application No. 2002-105680 filed on Apr. 8, 2002, whose priority is claimed under 35 USC§119, the disclosure of which is incorporated by reference in its entirety.

### BACKGROUND OF THE INVENTION

1. Field of the Invention

The present invention relates to a method for forming barrier ribs which partition a discharge space in a plasma display panel (hereinafter referred to as PDP). More particularly, the present invention relates to a method for forming barrier ribs using a sandblasting process in production of PDPs.

2. Description of the Related Art

A conventional method of forming barrier ribs of a PDP using the sandblasting process is illustrated in FIGS. 7(A) to 7(D). A low melting point glass paste is applied on a glass substrate 101 to form a barrier rib material layer 102 with a uniform thickness and dried. Then, the barrier rib material layer 102 is covered with a photoresist 103 that is resistant to the subsequent sandblasting thus functions as masks (See FIG. 7(A)).

With use of placing a photomask, the photoresist 103 is selectively exposed to ultraviolet light and developed after being stabilized chemically. Thereby forming masks 103 having identical patterns to the barrier ribs (See FIG. 7(B)). The sandblasting process is performed by blowing abrasive onto the entire barrier rib material layer 102 with the intervention of the patterned masks 103 to remove unmasked portions of the barrier rib material layer 102 (See FIG. 7(C)).

After the sandblasting, the barrier rib masks 103 on the barrier rib layer 102 are removed, and the barrier rib layer 102 is fired, thereby providing the barrier ribs 112 on the glass substrate 101 (See FIG. 7(D)). In the abovementioned sandblasting process, a nozzle through which the abrasive is jetted out with compressed air is moved imparrallel to band-shaped barrier rib patterns to be formed (as illustrated with arrow A in FIG. 7(C)).

According to the conventional method for forming barrier ribs as described above, the band-shaped barrier rib mask is used. In the sandblasting process, the abrasive rebounding from the glass substrate 101 engraves excessively the distal end of the barrier ribs 102 under the masks 103. Consequently concaves are formed as illustrated with dashed lines in FIGS. 7(C) and 7(D). In particular, in a fast sandblasting process for mass-production, the jet pressure, jet amount and mass of the abrasive are required to be set at large values, and the material of the abrasive is chosen to remove the barrier rib layer more quickly. As a result, the distal ends of the barrier ribs 112 formed of the portions of the barrier rib material layer 102 at the end of the masks 103 are removed largely because of factors set at the large values.

Such excess removal causes a problem that the masks 103 are separated from the barrier rib material layer 102 so that the mask is not broken apart in pieces but peeled off in blocks because of its certain degree of elasticity.

Another problem of the conventional method for forming barrier ribs is that protrusions 112a are formed at the barrier rib end (See FIG. 8) through firing since the band-shaped barrier ribs are continuously formed from end to end. These protrusions prevent a front substrate and a back substrate from contacting closely as illustrated in FIG. 9. When the PDP is actuated, erroneous illumination takes place in unselected unit luminous areas or cells (hereinafter referred to as cells) and unusual noise is generated at the protrusions. The problems may be solved by grinding the protruding end portions of the barrier ribs. However, this countermeasure brings extra time-consuming steps.

### SUMMARY OF THE INVENTION

The present invention provides a method for forming ribs for a plasma display panel, the method comprising: forming a rib material layer having a predetermined thickness; forming band-shaped barrier rib masks on the rib material layer, each of the barrier rib masks having a pattern corresponding to a barrier rib; forming at least one dummy rib mask for forming at least one dummy rib for each barrier rib, the dummy rib mask being spaced apart from an end of each barrier rib mask in a longitudinal direction of the barrier rib mask; and performing sandblast by blowing abrasive onto the rib material layer and the barrier rib and dummy rib masks, thereby forming the barrier ribs.

Thus, in the present invention, because the dummy rib mask are formed as corresponds to the barrier rib masks in a longitudinal extension of the ends of the barrier rib masks, the rib material layer around the dummy rib masks is cut at the same time as the rib material layer around the barrier rib masks is cut in the sandblasting process after the formation of the barrier rib masks and the dummy rib masks. The dummy ribs formed by the sandblasting process act to block off the abrasive rebounded by the glass substrate and to prevent the abrasive from reaching the ends of the band-shaped barrier ribs. The ends of the barrier ribs are less removed and are not excessively removed in a curved concave. Consequently, the barrier rib masks are not separated from the underlying rib material layer and the barrier ribs can be formed in a desired configuration with accuracy.

### BRIEF DESCRIPTION OF THE DRAWINGS

FIG. 1 is a plane view of barrier rib masks and dummy rib masks according to a first embodiment of the present invention.

FIGS. 2(A) and 2(B) are enlarged illustrations of a main portion of FIG. 1.

FIGS. 3(A) and 3(B) are a perspective view and a side view, respectively, of barrier ribs and dummy ribs provided after a firing process according to the first embodiment of the present invention.

FIGS. 4(A) and 4(B) are plane views, with a main portion enlarged, of barrier rib masks and dummy rib masks according to other embodiments of the present invention.

FIGS. 5(A) and 5(B) are a perspective view and a side view, respectively, of barrier ribs and dummy ribs after a firing process according to another embodiment of the present invention

FIGS. 6(A) and 6(B) are a perspective view and a side view, respectively, of barrier ribs and dummy ribs after a firing process according to another embodiment of the present invention

FIGS. 7(A) to 7(D) illustrates a barrier rib forming process according to a prior art.

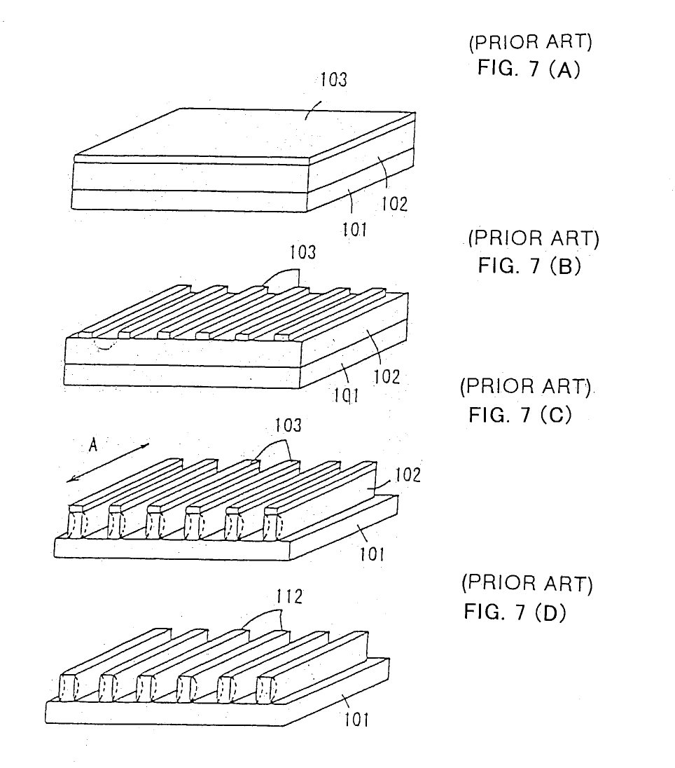

FIGS. 8 (A) and 8 (B) are a perspective view and a side view, respectively, of barrier ribs after a firing process according to a prior art.

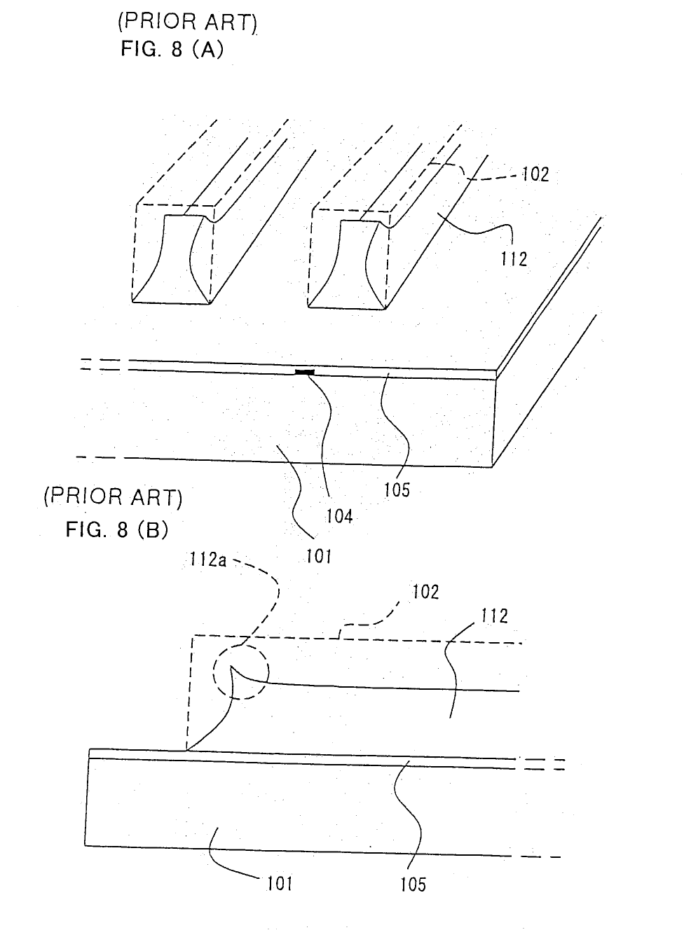

FIG. 9 is a cross-sectional view of an assembly of a front and a back substrate according to a prior art.

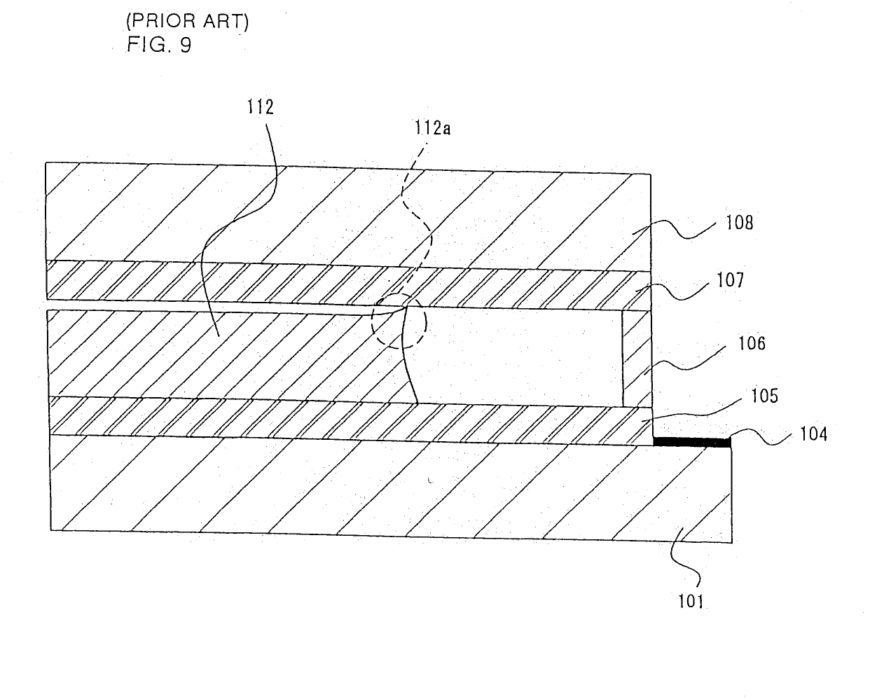

### DETAILED DESCRIPTION OF THE PREFERRED EMBODIMENTS

This invention provides a manufacturing method for barrier ribs of a PDP that prevents masks from separating from the barrier rib material layer in the sandblasting process, also allows band-shaped barrier ribs to have a constant width throughout a display area, and preventing the barrier rib ends from protruding, whereby the PDP is capable of clear displays.

According to another aspect of the present invention, a plurality of dummy rib masks are formed with respect to each barrier rib mask in order to form a plurality of dummy ribs for each barrier rib.

Thus, in the present invention, a plurality of dummy rib masks are formed with respect to each barrier rib mask. Even if one or more dummy ribs are removed by the abrasive rebounded by the glass substrate when the rib material layer around the dummy rib masks is cut in the sandblasting process after the formation of the barrier rib masks and the dummy rib masks, the abrasive rebounded by the glass substrate is blocked off by at least one dummy rib, if it remains, and thereby the amount of the rebounded abrasive is decreased. Therefore, the ends of the barrier ribs are not excessively removed in a curved concave. Consequently, the barrier rib masks are not separated from the underlying rib material layer and the barrier ribs can be formed in a desired configuration with accuracy.

According to yet another aspect of the present invention, at least one end of each barrier rib mask is formed in a round shape and/or at least one end of each dummy rib mask is formed in a round shape.

Thus, in the present invention, because the ends of the barrier rib masks and the dummy rib masks are formed in the round shape, the ends of the barrier ribs and the dummy ribs are formed in the round shape through the sandblasting process after the formation of the barrier rib masks and the dummy rib masks. During firing after the sandblasting process, relatively uniform tension is generated at the ends of the barrier ribs, and the ends of the barrier ribs are less protruded. Therefore, when the front and back substrates are assembled, they are brought into completely close contact with each other because the height of the barrier ribs is constant. Cells other than selected cells do not emit light erroneously. The PDP can display proper images and can operate without generating unusual noise.

According to yet another aspect of the present invention, at least one end of each barrier rib mask is formed in a tapered shape and/or at least one end of each dummy rib mask is formed in a tapered shape.

According to yet another aspect of the present invention, the dummy rib mask has a width greater than that of the barrier rib masks.

Thus, in the present invention, because the width of the dummy rib masks is greater than that of the barrier rib masks, the dummy ribs are formed wider than the barrier ribs in the sandblasting process after the formation of the barrier rib masks and the dummy rib masks. Then , when the rib material layer around the barrier rib masks is cut, the abrasive rebounded by the glass substrate is considerably blocked off by the dummy ribs and the amount of the rebounded abrasive is significantly decreased. The ends of the barrier ribs are cut into a curved concave only a little. Therefore, the barrier rib masks do not separate from the underlying the rib material layer and the barrier ribs can be formed in a desired configuration with accuracy.

According to yet another aspect of the present invention, the dummy rib mask has a length not greater than 2 mm. Thus, in the present invention, the dummy rib masks have a length of 2 mm or less. Even if uneven tension is generated at the ends of the dummy ribs during firing after the sandblasting process, only small protrusions emerge because the dummy ribs are short. The front and back substrates are brought into completely close contact with each other when assembled without being prevented from close contact. Therefore, cells other than selected cells do not emit light erroneously, and the PDP can display proper images and can operate without generating unusual noise.

PDPs according to the present invention have the dummy ribs that are formed by the method described above.

Embodiment 1

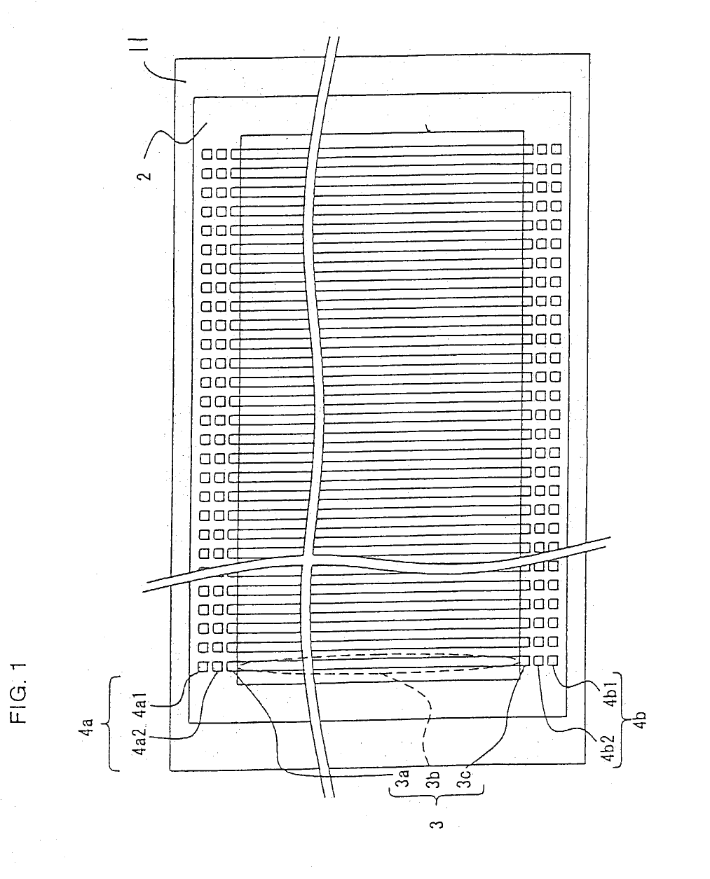

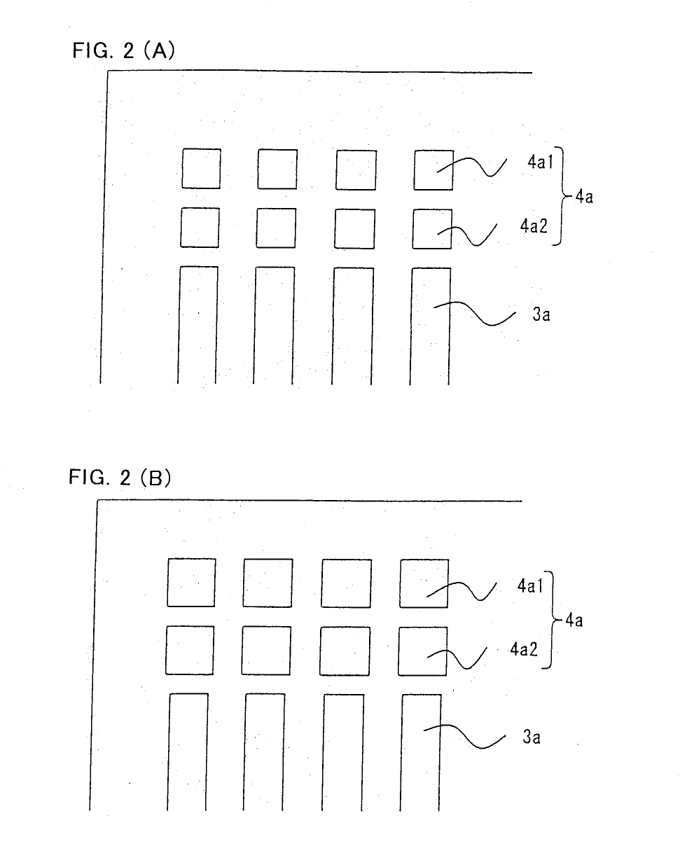

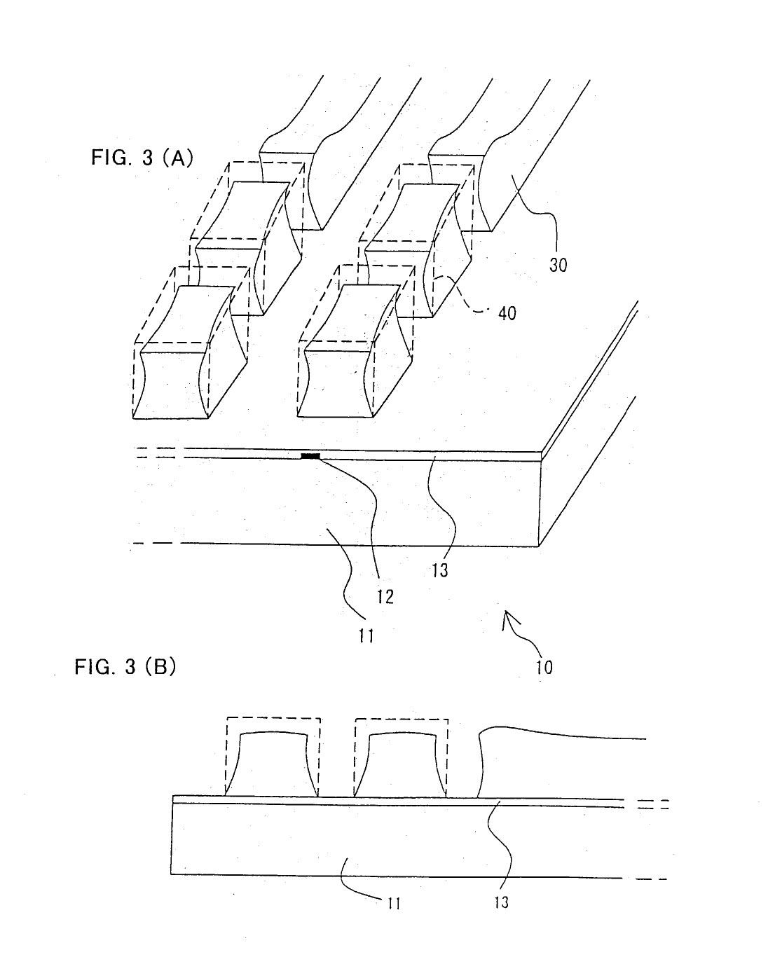

A method for forming barrier ribs of a PDP according to a first embodiment of the present invention is described below referring to FIGS. 1 to 3. FIG. 1 is a plane view of patterns of barrier rib masks and dummy rib masks according to the embodiment. FIGS. 2(A) and 2(B) are enlarged illustrations of a main portion of FIG. 1. FIGS. 3(A) and (B) are a perspective view and a side view, respectively, of barrier ribs and dummy ribs after a firing process according to the embodiment.

According to this embodiment, the method for forming barrier ribs for use in a PDP includes the following processes before sandblasting: first, address electrodes 12 to select cells are formed on the surface of a glass substrate 11 in a back substrate 10 on which barrier ribs are to be formed, and then, a dielectric layer 13 is formed on the address electrodes 12 to cover them. Subsequently, a rib material layer 2 of predetermined thickness is formed on the glass substrate 11. Either applying a low melting point glass paste to glass substrate 11 followed by drying, to form a glass layer or adhering a unfired sheet-type glass layer on the glass substrate 11 can provide the rib material layer 2. A dry film made of photoresist is adhered on the rib material layer 2. The photoresist layer is exposed to ultraviolet light with a photomask placed on the surface thereof. The photomask has an opening corresponding to the patterns of the barrier ribs and dummy ribs.

By this exposure, the dry phororesist film is formed into patterns identical to the patterns of the barrier and dummy ribs as corresponds to the opening, thereby forming barrier rib masks 3 and dummy rib masks 4.

The shape of the barrier rib masks 3 corresponds to the band-shaped barrier ribs to be formed in the rib material layer 2, and the provided barrier ribs partition the discharge space in the display area as well as in a non-display area adjacent to the display area. The dummy rib masks 4 having a rectangular shape are placed in the non-display area, on the extension of the barrier rib masks, adjacently to each barrier rib mask end at some distance (See FIG. 2(A)).

After the above-mentioned processes for forming the barrier rib masks 3 and dummy rib masks 4 on the rib material layer 2, the sandblast process follows. In the sandblasting process, an abrasive jetted out from nozzle (not shown) removes the rib material layer 2. However, the material of the barrier rib masks 3 and the dummy rib masks 4 are not removed in that process because of its elasticity. Thus portions of the rib material layer 2 on which the barrier rib masks 3 or the dummy rib masks 4 lie cannot be cut from above.

By this sandblasting, the rib material layer 2 on the glass substrate 11 with the barrier rib masks 3 and dummy masks 4 formed thereon is cut in the longitudinal direction in which the barrier rib masks extend.

The sandblasting starts from the side where the dummy rib masks 4a are formed, whereby a plurality of dummy ribs 40 corresponding to the barrier rib masks 3 are formed. At this time, preferably, all dummy ribs 40 are formed corresponding to a plurality of dummy rib masks 4a1 and 4a2. However, in some cases, the abrasive rebounded from the glass substrate 11 concave the end of the rib material layer 2, and finally the mask 4a1 is separated from the rib material layer 2. As a result, the rib material layer 2 is removed and the dummy rib 40 is not formed.

The dummy rib masks 4a1 and 4a2 are provided in consideration of such cases. Even if the outer most dummy rib 40 is not formed because of separation of the mask 4a1, the inner dummy rib is formed since the inner mask 4a2 remains. Consequently, the inner dummy rib protects the inner barrier rib. If the inner dummy rib adjacent to the barrier rib mask 3 is not formed because of separation of the mask 4a2, at least one dummy rib, if it remains, has the effect of suppressing the abrasive rebounding from the glass substrate 11 at sandblasting the rib material layer 2 covered with the barrier rib masks 3.

The sandblasting near the dummy rib masks 4a1, 4a2 and the end portion 3a of the barrier rib mask 3 forms corresponding dummy ribs 40 and the end portion of the barrier rib. At this time, the abrasive blown through the nozzle rebounds from the glass substrate 11 and concave the distal end of the rib material layer 2 formed under the mask 3a. However, the dummy ribs 40 suppress excess removal of the barrier rib end with reducing the abrasive's kinetic energy.

Subsequently, the center potion of the barrier rib mask 3, which is indicated as 3b, is sandblasted to provide the center portion of barrier rib 30, followed by sandblasting another end portion of the barrier rib mask 3, indicated as 3c. Finally, the portion around dummy end rib masks 4b, on the side opposite of the already formed dummy ribs 40, is sandblasted to form dummy ribs 40. During the sandblasting near the dummy rib masks 4b, the abrasive concave the other end of the already formed barrier rib 30 formed under the mask 3c. However the forming dummy ribs 40 suppress excess removal of the barrier rib end since they reduce the abrasive's kinetic energy.

After the sandblasting process, the barrier rib masks 3 and dummy rib masks 4 are removed. The remaining glass paste that forms the ribs on the glass substrate 11 are dried and fired. By firing, a binder of the glass paste is burned out and solid particles of the glass paste are fixed firmly to each other. FIG. 3 illustrates the glass substrate 11 after the firing process. FIG. 3(B) is a side view of FIG. 3(A). Protrusion at the ends of the barrier ribs 30 after the firing process is fairly small since the ends of the barrier ribs 30 are not concaved deep because of the protection by the dummy ribs 40.

According to this embodiment, at the ends of the barrier rib masks 3, the ends of the rib material layer 2 is not removed excessively but removed appropriately. Thus the barrier rib masks 3 are not separated from the rib material layer 2, which results in little side etching effect. Thus the accurate formation of barrier ribs 30 is ensured in the sandblasting process. This accurate formation of barrier ribs 30 further suppresses protruding at the ends of the barrier ribs 30 after the firing process, and also eliminates causes that will bring problems in assembled PDPs.

In the method for forming barrier ribs of a PDP, according to this embodiment, the dummy rib masks 4 may have a width greater than that of the barrier rib masks 3 as illustrated in FIG. 2(B). The dummy rib masks 4 having a greater width provide wider dummy ribs 40 that protect the barrier rib ends more efficiently. The abrasive rebounded by the glass substrate 11 is mostly cut off by the wider dummy ribs 40 and the amount of the abrasive reaching the barrier rib ends is decreased sharply. Thus the barrier rib masks 3 are not peeled from the barrier rib layer 2, and that results in accurate formation of the barrier ribs 30.

Other Embodiments

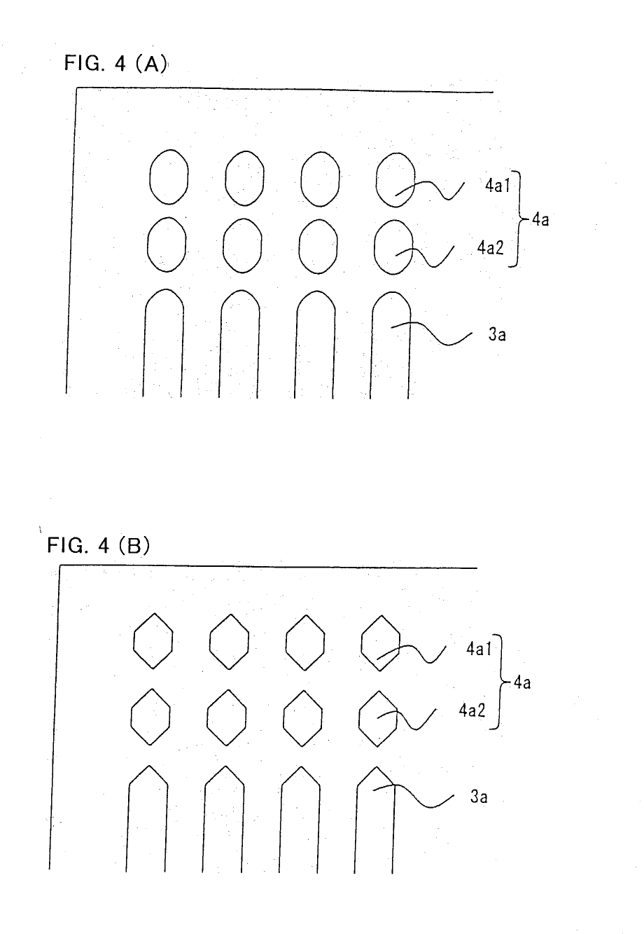

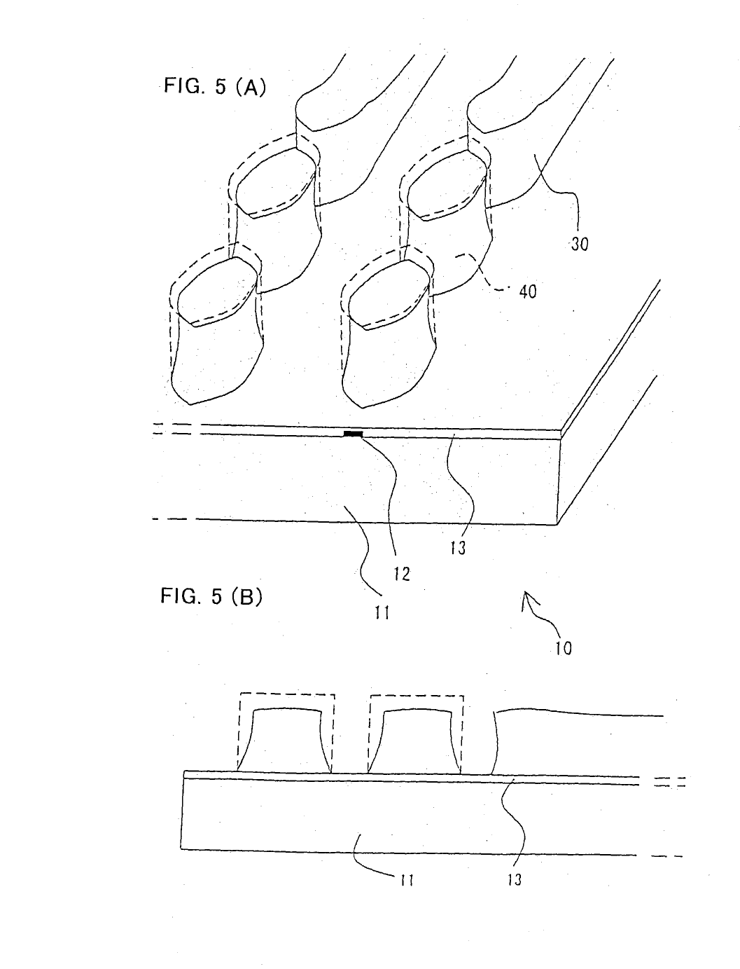

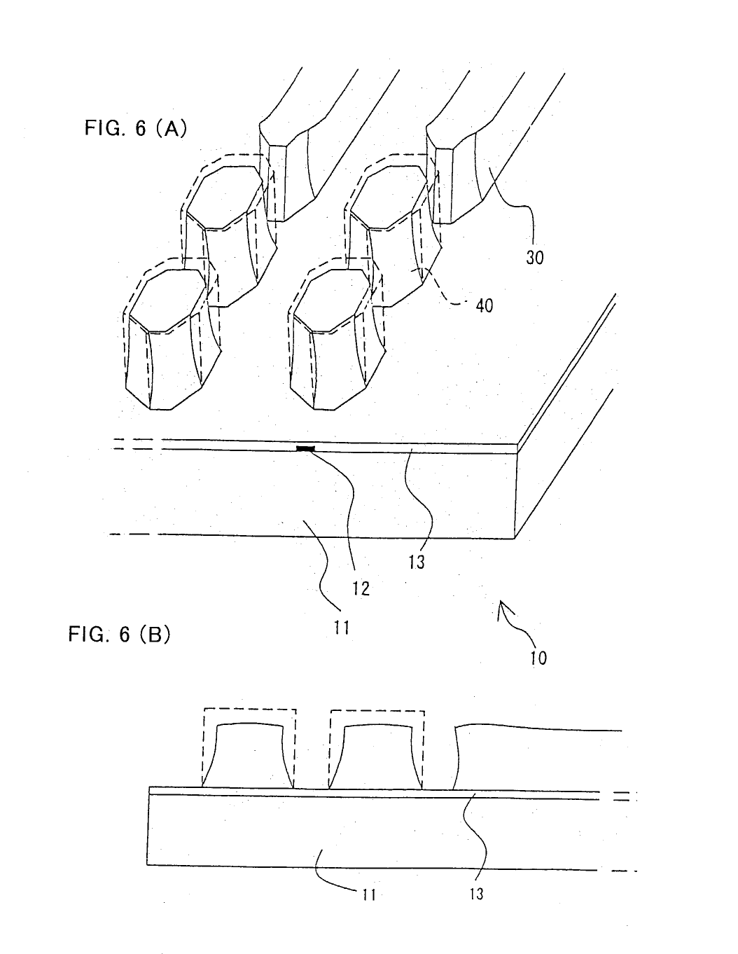

FIG. 4(A) is a plane view of barrier rib masks and dummy rib masks according to another embodiment of the present invention. According to another embodiment of the present invention as illustrated in FIG. 4(A), the barrier rib masks 3 and the dummy rib masks 4 are formed on the rib material layer as in the above-described embodiment 1. In addition to that, the ends of the dummy rib masks 4 and/or barrier rib masks 3 have a round shape. Therefore, at burning the glass substrate 11, the glass paste compresses by the burning of the binder of the glass paste in the firing process. The tension caused by compression of the glass paste is well distributed equally because of the rounded ends, thereby reducing the protrusion at the ends of barrier ribs or dummy ribs. FIG. 5 illustrates the glass substrate 11 after the firing process. FIG. 5(B) is a side view of FIG. 5(A). The ends of the dummy rib masks 4 and barrier rib masks 3 may have a tapered shape as illustrated in FIG. 4(B). That brings the same effect. FIG. 6 illustrates the glass substrate 11 after the firing process. FIG. 6(B) is a side view of FIG. 6(A).

According to still another embodiment of the present invention, the barrier rib masks 3 and the dummy rib masks 4 are formed on the rib material layer as in the above-described embodiment 1. In addition to that, the dummy rib masks 4 have a length not greater than 2 mm. Since the length of the end ribs are short, the protrusions on the dummy ribs that are formed by compressional tension in the glass paste caused by the burning of the binder of the glass paste binder in the firing process are so small that the front and back substrate can contact closely in assembly. That is because the dummy ribs 4 are small and accordingly the compressional stress is also small. Dummy rib masks 4 longer than 2 mm would result in formation of rather big protrusions at the barrier rib ends through the firing process, though the size of the protrusions depend on the shape of the dummy end rib masks 4, and thus close contact of the front and back substrates cannot be obtained. The minimum length of the dummy rib masks 4 depends on resolution of a photolithography machine used for exposing the photoresist. Since the resolution is about 0.05 mm in today's technology, the minimum length is also about 0.05 mm. This would be shortened in future depending on improvement of the machine's accuracy.

According to the present invention, one or more dummy rib masks are placed, on the extension of an end or ends each barrier rib mask, adjacently to the end or ends of the barrier rib mask at some distance. With subsequent sandblasting process, the rib material layer around the dummy rib masks, as well as the barrier rib masks, is removed, thereby providing dummy ribs. The method of the present invention has effects that the dummy ribs protect the barrier rib ends and reduce the amount of rebounding abrasive that reaches the barrier rib ends and concaves their surface. Thus the barrier rib masks are not peeled from the rib material layer, and that results in accurate formation of the barrier ribs.

The method of the present invention also has effects that in case any of the dummy rib masks is peeled off during the sandblasting process, but if at least one remains, a corresponding dummy rib is formed. The dummy rib protect the barrier rib end and reduces the amount of rebounding abrasive that reaches the barrier rib ends and concave their surface. Thus the barrier rib masks are not peeled from the rib material layer, and that results in accurate formation of the barrier ribs.

According to the present invention, the ends of the barrier rib masks and dummy rib masks are formed in a round shape. Therefore the invention also has effects that in the firing process which follows the sandblasting process, compressional stress is well distributed because of the rounded ends, and thereby the protrusion formation is suppressed at barrier rib ends and/or dummy ribs. Thus the invention provides a PDP free from erroneous illumination of unselected cells or noise.

According to the present invention, the dummy rib masks has a greater width than that of the barrier rib masks. Therefore the invention also has effects that the dummy ribs having greater width provide wider dummy ribs that protect the barrier rib ends more efficiently and a decreased amount of rebounding abrasive reaches the barrier rib ends and concave their surface. Thus the barrier rib masks are not peeled from the rib material layer, and that results in accurate formation of the barrier ribs.

According to the present invention, the dummy rib masks has a length of 2 mm or less. Therefore the invention also has effects that because of short length, that is not greater than 2 mm, of the dummy rib masks, protrusions on the dummy ribs that are formed by uneven stress in the firing process are so small that the front and the back substrate can contact closely in assembly. Thus the invention provides a PDP free from erroneous illumination of unselected cells or noise.

What is claimed is:

1. A method for forming ribs for a plasma display panel, the method comprising:
forming a rib material layer having a predetermined thickness;
forming band-shaped barrier rib masks on the rib material layer, each of the barrier rib masks having a pattern corresponding to a barrier rib;
forming at least one dummy rib mask for forming at least one dummy rib for each barrier rib, the dummy rib mask being spaced apart from an end of each barrier rib mask in a longitudinal direction of the barrier rib mask; and
performing sandblast by blowing abrasive onto the rib material layer and the barrier rib and dummy rib masks, thereby forming the barrier ribs.

2. The method according to claim 1, wherein a plurality of dummy rib masks are formed with respect to each barrier rib mask in order to form a plurality of dummy ribs for each barrier rib.

3. The method according to claim 1 or 2, wherein at least one end of each barrier rib mask is formed in a round shape and/or at least one end of each dummy rib mask is formed in a round shape.

4. The method according to claim 1 or 2, wherein at least one end of each barrier rib mask is formed in a tapered shape and/or at least one end of each dummy rib mask is formed in a tapered shape.

5. The method according to claim 1, wherein the dummy rib mask has a width greater than that of the barrier rib masks.

6. The method according to claim 1, wherein the dummy rib mask has a length not greater than 2 mm.

7. A plasma display panel comprising a dummy rib formed by a method as set forth in claim 1.
